(19) United States
(12) Patent Application Publication
(10) Pub. No.: US 2012/0162754 A1
(43) Pub. Date: Jun. 28, 2012

(54) Pinhole for a Confocal Laser Scanning Microscope

(76) Inventor: Mirko LIEDTKE, Jena (DE)

(21) Appl. No.: 13/334,195

(22) Filed: Dec. 22, 2011

(30) Foreign Application Priority Data
Dec. 22, 2010 (DE) DE102010055882.6

(51) Int. Cl. G02B 21/06

(52) U.S. Cl. 359/385

(57) ABSTRACT

A laser scanning microscope comprising having a light source, an illuminating beam for illuminating a specimen with a spatially limited, preferably point-shaped, illuminating light spot via a scanning device and an objective lens, and a detection beam for detecting the specimen light that reaches the detection beam via the objective lens and the scanning device. Focusing means that are disposed in the detection beam and focus the light from the specimen to form a spatially limited detection light spot in a plane. Receiver elements are distributed in the spot in a matrix-like manner and can be individually read out. These are located in order to simulate an adjustable pinhole aperture.

### RELATED APPLICATIONS

The present application claims priority benefit of German Application No. DE 10 2010 055 882.6 filed on Dec. 22, 2010, the contents of which are incorporated by reference in its entirety.

### FIELD OF THE INVENTION

The invention relates generally to the field of confocal laser scanning microscopes and more particularly to the pinhole of such microscopes.

### BACKGROUND OF THE INVENTION

Confocal laser scanning microscopes are well known. A schematic diagram of such a microscope is illustrated in FIG. 1. The microscope of FIG. 1 includes a microscope unit M and a scanning unit S which share an optical interface via an intermediate image Z, and a detection unit for the descanned detection D and an additional detection unit for the non-descanned detection NDD. The scanning unit S can be connected both to the phototube of an upright microscope and to a lateral output of an inverted microscope. The microscope unit M has a lens 4 and a tubular lens 9 for viewing a specimen 5. The excitation light source used is a laser 10, the laser beam of which, after being excited, initially propagates freely and passes through an acousto-optical component 11, e.g., an AOTF. Via an optical coupling system 12 and an optical fiber 13, the laser beam is subsequently coupled into the illuminating beam path of the scanning unit S. Using the control unit 2, the laser beam can be cut out by means of the acousto-optical component 11.

The scanning unit S includes an optical collimating system 16, a path-folding mirror 17, a scanning objective lens 22, a scanner 23 and a main color beam splitter 24. Via an optical pinhole system 29 with a central pinhole (pinhole aperture) through which the detection light D travels, the light emitted by the specimen is passed into the detection unit C. Via a secondary color beam splitter 26, the light from the specimen is spectrally separated and guided via optical imaging systems 25 to a plurality of detectors 31.

In addition, or as an alternative, the microscope can also have a non-descanned detection unit NDD. In that case, light from the specimen passes via an NDD beam splitter 27 that is preferably disposed near the objective lens into the non-descanned detection unit NDD. The non-descanned detection unit can also be used in the transmitted light as known from the prior art (not shown).

This type of laser scanning microscope is also the subject matter of DE 197 02 753 A1. This document describes a plurality of detection pinholes in various individual beam paths downstream of a shared optical pinhole system, the diameter of which pinholes can be changed. Furthermore, to compensate for optical aberrations of the optical system of the microscope, these detection pinholes are designed so as to be axially and laterally controllable and movable relative to the detection beam.

To compensate for the aberrations of the optical system, other approaches have been proposed, e.g., adaptive optical systems or deformable mirrors (EP 929 826 B1).

According to the present invention, it was found that it is easier to make these corrections in the detector itself by creating a spatially resolving surface receiver in such a manner that, for example, preferably only the regions of the light-sensitive surface that also contribute to the image content are analyzed,

This will be the subject matter of the independent claims.

Preferred advanced embodiments will be the subject matter of the dependent claims.

In contrast to the prior art (CCD receiver matrices that are read out serially), the present invention proposes a detector matrix that is not read out completely (a considerable time disadvantage, which renders this approach unusable for point scanners), but where each individual pixel is read out separately, although it can optionally also be binned (combined).

By targetedly selecting active and inactive pixels, it is, for example, even possible to simulate an extremely variable pinhole.

Hereinafter, the terms pinhole and pinhole aperture will be used interchangeably and are defined, in particular, as pinhole apertures, the diameters of which can be adjusted.

To this end, the receiver is placed into the pinhole plane in the detection beam. If a larger pinhole is needed, simply more pixels are binned. It is also no longer necessary to adjust a pinhole because now all that is necessary is to use additional pixels.

Similarly, it is possible to improve the imaging of aberrations from the optimum since the detection spot will not necessarily always be round.

Even more complex imaging errors can be detected and parts of the image that would normally have been cut off by the pinhole can be visualized by separately detecting and analyzing these areas.

Because these areas can be viewed separately, it is possible, given that the apparatus function is known, to subtract the optical errors out of the system and to increase the resolution of the system.

In addition, by varying the spot shapes, it may be possible to determine the focus, for example, whether above or below the focal plane.

The detector elements used can be diodes, APDs, PMTs or any other suitable element, provided that each sensor can be read out individually, thus ensuring readout times shorter than 1 μsec, such as are needed in an LSM.

The invention can be applied both in laser scanning microscopes having a plurality of pinholes in separate detection channels that have been split by dichroic beam splitters and, to especially great advantage, in cases of simultaneous illumination with a plurality of point light sources, as described in U.S. Pat. No. 6,028,306, with several receiver arrays according to the present invention being placed in the areas in the detector in which pinhole apertures had previously been located.

These receiver arrays can subsequently be individually adjusted to the distributions of incident light; however, for example, after an individual adjustment, it is also possible to synchronously change the direction of these arrays, e.g., for “oversampling,” as described below.

### BRIEF DESCRIPTION OF THE DRAWINGS

The invention will be described in greater detail below in connection with annexed drawings, in which:

FIG. 1 is a schematic drawing illustrating a confocal laser scanning microscope;

FIGS. 2-6 show examples of analyses of a receiver matrix;

FIG. 7 shows a readout scheme for an APD (avalanche photodiode) matrix; and

FIG. 8 shows the readout of a PMT receiver matrix.

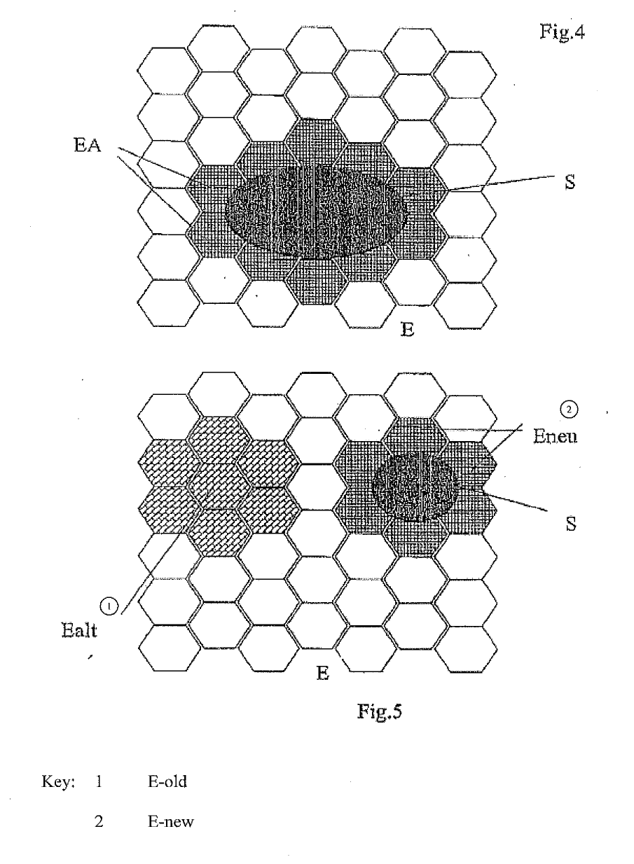

The drawings in FIGS. 4-6 have in common that they show receivers E that are arranged in a matrix-like array and that can be read out individually, a beam spot S that is focused on the matrix, the detection beam and activated (read-out) detectors EA of the detection matrix.

In FIG. 2, the size and location of the beam spot S is such that only a single detector element EA needs to be read out.

The location of spot S on the matrix can be determined, for example, by alternately enabling and disabling individual elements E prior to the actual measurement (the scanning procedure).

This obviates the laborious correction described above that is necessary in the prior art, yet makes accurate measurements possible.

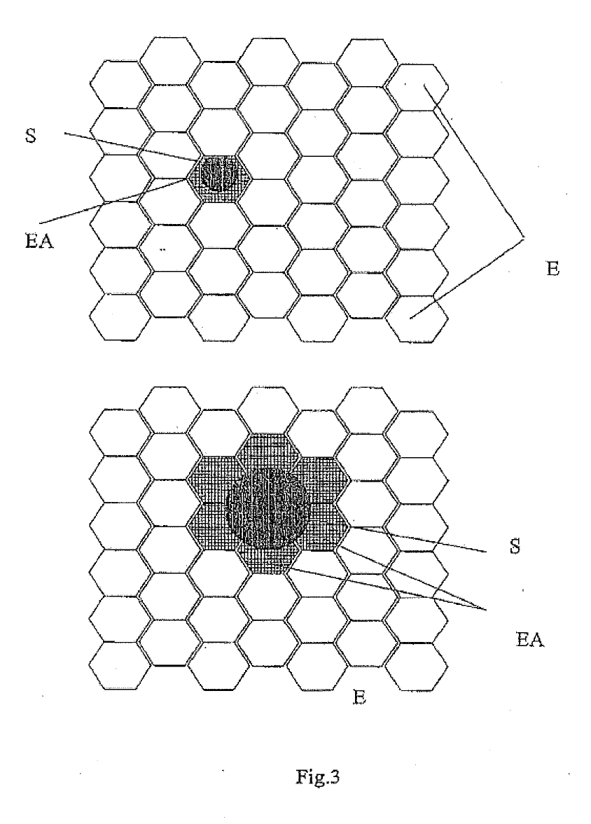

As illustrated in FIG. 3, in order to analyze a larger spot S, a plurality of elements EA are activated and can be read out, the effect of which in this figure is that they simulate a pinhole larger than that in FIG. 2.

FIG. 4 shows a spot S, the shape of which is ellipsoid rather than round and which, in spite of this, can be completely read out due to the ellipsoidal distribution of the active elements EA.

In contrast to the prior art, the use of the active receiver elements makes it possible for the pinhole to assume nearly any shape, while the pinhole apertures up to now had generally been limited to round, square, or rhombic shapes.

By deactivating the remaining elements E of the receiver matrix, the stray light and any other undesirable light that does not originate from the focal point in the specimen is suppressed.

The size of the pinhole can also be changed by targetedly increasing or decreasing the number of activated elements immediately prior to repeating a scanning procedure in order to generate a scanned image. This approach is used, for example, in so-called “oversampling” with a reduction of the pinhole size, and can here be implemented especially easily.

Obviously, instead of “oversampling,” undersampling with an increased pinhole diameter is possible as well.

The special advantage of this invention is its variability, without having to use mechanical elements for adjustments.

While thus far the pinhole had to be laboriously shifted (as mentioned above), it is now possible, as illustrated in FIG. 5, to simply replace the previously activated receiver element E-old with a new receiver element E-new according to the location of S.

This situation can arise relatively frequently, for example, when changes to the microscope optical system have to be made, such as when switching between lenses or objective lenses, which can now be easily controlled and automated.

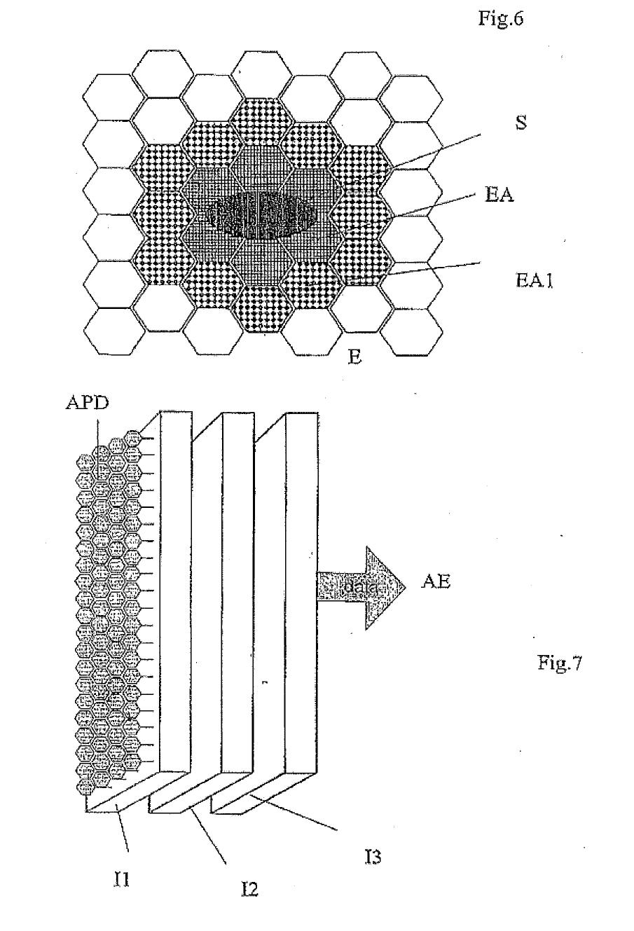

In addition to the active receiver distribution EA, FIG. 6 also shows a receiver distribution EA1 that is grouped around the first receiver distribution. This can be useful if the size and/or the shape of the spot changes.

This can occur if a Z-adjustment of the specimen is made at a constant focus.

Based on the change in shape and size, information as to the height can be obtained.

For example, if the elements EA1 and spot S are exposed to light, this can trigger, for example, a control signal indicating that the height needs to be corrected (refocusing).

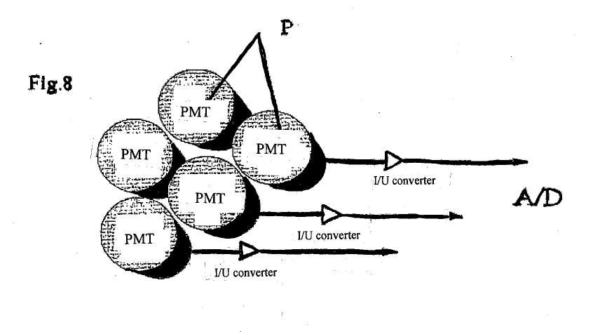

FIG. 7 shows an implementation example of an APD matrix on an integrated circuit I1 which can be connected to additional circuits, for example, an amplifier circuit I2 and a counter circuit I3, for example, in an “interconnect” circuit.

For example, I1 can represent the counters of the individual photons that are detected, after receipt of a photon, by the respective APD before it is reset by the internal erase circuit that individually reads out (counts) the signals (photons) of the individual APDs and relays them to a router in I2; in I2, the individually counted light pulses are adjustably linked and are routed, for example, in I3, via a GPU (graphic processing unit) in the direction of an analyzing unit (computer) AE so as to relieve the central computer and to assemble the image by synchronization with the scanning procedure.

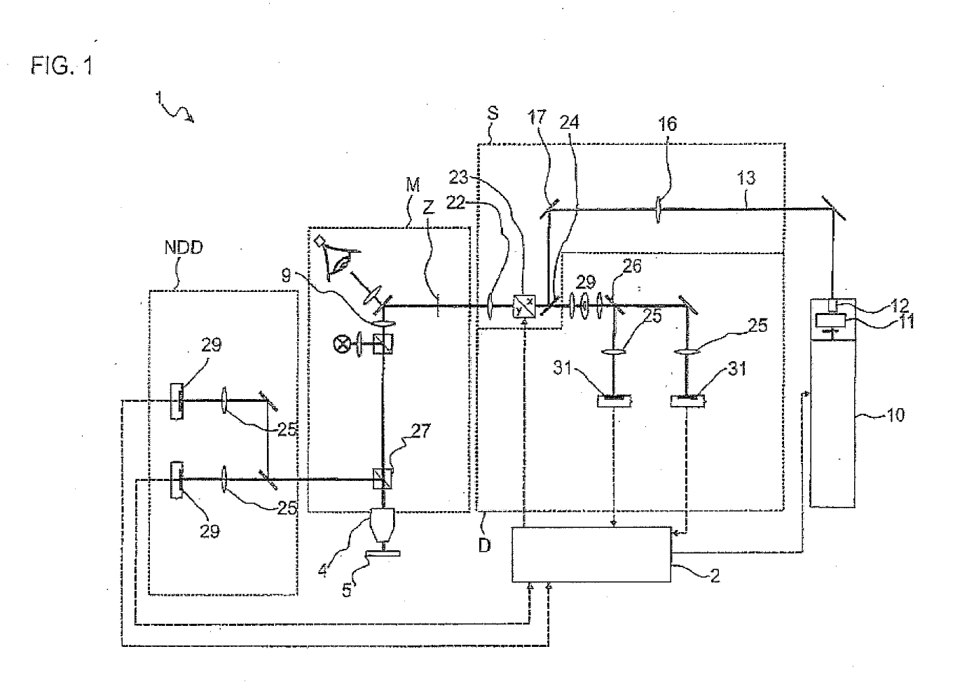

In FIG. 8, a plurality of PMTs, which are read out individually via I/U converters and AD converters A/D as shown, are arranged as illustrated in FIGS. 1-7.

Because of the relative sizes of the diameters of the APD and the PMT (APD approximately 150 μm, PMT 20 mm), the person skilled in the art, while focusing the system, will obviously have to change the optical conditions (beam expansion) if, instead of APDs, PMT matrices are used.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

1. An adjustable pinhole aperture for a confocal laser scanning microscope, comprising a two-dimensional, preferably matrix-like distribution of receiver elements that can be read out individually.

2. A laser scanning microscope with a light source, an illuminating beam for illuminating a specimen with a spatially limited, preferably point-shaped illuminating light spot, via a scanning device and an objective lens and with a detection beam for detecting the specimen light that reaches the detection beam via the objective lens and the scanning device, with focusing means that are disposed in the detection beam and focus the light from the specimen to form a spatially limited detection light spot into a plane in which receiver elements that are distributed in a two-dimensional, preferably matrix-like manner and that can be individually read out are located to simulate an adjustable pinhole aperture.

3. The laser scanning microscope as in claim 2 having a simultaneous multi-point scanner with a minimum of two illuminating light spots and a detector with at least two detection beams, which detector is dedicated to these illuminating light spots.

4. The laser scanning microscope as in claim 2, with a first group of detection elements for detecting the detecting light spot and, grouped around this first group, a second group of detection elements being provided, and with a light-detector system, in combination with the second group, forming a control signal for Z-focusing or an analyzing signal for detecting a defocusing state.

5. A method of using an adjustable pinhole aperture in a laser scanning microscope, comprising positioning receiver elements in the region previously occupied by a pinhole aperture, and individually reading out said receiver elements, wherein only a region that is exposed to detection light by means of a detection light spot is detected by variably linking the signals of a number n−1 of receiver elements.

6. The method as in claim 5 wherein, after acquisition of a scanned image, the detected region and/or the number of read-out receiver elements, and thus the size of the pinhole aperture, is/are decreased or increased and at least one more scanned image is acquired by a two-dimensional scan of an image region.

7. The method as in claim 5 wherein the shape of a group of read-out receiver elements is made to conform to the shape of the detection light spot.

8. The method as in claim 5 wherein, prior to a change in the operating conditions of the LSM, preferably prior to a change in the optical system or prior to a first image acquisition, the region exposed to detection light is located by reading out the receiver elements and is utilized at least in part for the detection in the subsequent detection procedure.

9. The method as in claim 5 wherein, after locating the exposed region, a group of detection elements that shares a point of symmetry or an axis of symmetry with this region is utilized for detection.

10. The method as in claim 5 wherein a first group of detection elements for detecting the detection light spot and, grouped around this first group, a second group of detection elements are provided and a light detecting system, in combination with the second group, forms a control signal for Z focusing or an analyzing signal for detecting a defocusing state.

11. The method as in claim 5 wherein the laser scanning microscope is operated with a simultaneous multi-point scanner with at least two illuminating light spots and a detector with at least two detection beams, which detector is dedicated to the two illuminating light spots.
